(19) United States
(12) Patent Application Publication
(10) Pub. No.: US 2019/0094025 A1
(43) Pub. Date: Mar. 28, 2019

(54) APPARATUS AND METHOD FOR LOCALISING A VEHICLE

(71) Applicant: JAGUAR LAND ROVER LIMITED, Warwickshire (GB)

(72) Inventors: Qian Lu, Whitley (GB); Mostafa Taie, Whitley (GB)

(21) Appl. No.: 16/122,944

(22) Filed: Sep. 6, 2018

(30) Foreign Application Priority Data
Sep. 27, 2017 (GB) 1715624.1

(51) Int. Cl. G01C 21/00

(52) U.S. Cl. CPC G01C 21/005; B60W 30/06

(57) ABSTRACT

Embodiments of the present invention provide a method, an apparatus, an electronic system and a vehicle for proactively localising a vehicle. The method comprises determining that the vehicle is approaching an end of a journey, sensing one or more features of an environment proximal to the vehicle and, upon determining that the vehicle is approaching the end of the journey, localising the vehicle in dependence on said sensing. The apparatus comprises means for receiving one or more signals indicative of a position in a journey of the vehicle, processing means for determining, in dependence on said one or more signals, whether the vehicle is approaching an end of a journey and sensing means for sensing one or more features of an environment proximal to the vehicle. The processing means is arranged to localisation the vehicle in dependence on said sensed features, upon determining that the vehicle is approaching the end of the journey.

### CROSS REFERENCE TO RELATED APPLICATION

This application claims priority to United Kingdom Patent Application No. GB 1715624.1, which was filed on 27 Sep. 2017.

### TECHNICAL FIELD

The present disclosure relates to an apparatus and method for localising a vehicle. Particularly, but not exclusively, the disclosure relates to a method and apparatus for proactively localising a vehicle, such as for automated parking and low speed automated manoeuvring. Aspects of the invention relate to a method, to an apparatus, to an electronic system, and to a vehicle.

### BACKGROUND

High precision vehicle localisation is crucial for realising autonomous parking features of a vehicle. Indeed, one of the main challenges in autonomous parking scenarios is to locate a starting position of the vehicle. The vehicle, or at least a system, a controller or an apparatus associated therewith, requires accurate information regarding a position of the vehicle relative to its surroundings, in order to plan a manoeuvre to reach a target parking position. Such information is also required in order for the vehicle to react appropriately to any encountered stationary or moving obstacles or pedestrians throughout execution of the manoeuvre.

Perhaps the most common vehicle localisation technique at present is GPS. However, with a typical accuracy of approximately 10 metres, GPS does not provide sufficient accuracy required for high precision vehicle localisation. Furthermore, GPS coverage is not always available, such as in roofed or underground car parks, or in a high density urban environment. In recent years, a more accurate solution, referred to in the art as differential GPS (DGPS) has emerged. Although DGPS provides improved accuracy (approximately 10 centimetres), it suffers the same problem of loss of coverage in certain environments, such as roofed or underground car parks, or in crowded urban environments. Furthermore, DGPS is expensive and requires one or more towers on a roof of the vehicle, which negatively impacts aerodynamics and aesthetics of the vehicle.

Consequently, other environmental sensors on board the vehicle, such as RADAR (radio detection and ranging), LIDAR (light imaging, detection and ranging), cameras and ultrasound sensors may be used for high precision vehicle localisation with more accuracy than GPS. Although these are not necessarily limited by a particular parking environment, they involve high consumption of computation power and memory, resulting in a delay between a user requesting the vehicle to perform an automated parking manoeuvre and the vehicle carrying out said manoeuvre. Indeed, a user typically initiates automated parking once the vehicle has stopped, meaning that the vehicle or at least a system, a controller or an apparatus associated therewith, must perform vehicle localisation when the vehicle is in a stationary state. Many on board environmental sensors require motion of the vehicle in order to operate to their best ability, and therefore static localisation cannot make full use of all available environmental on board vehicle sensors. RADAR systems operate relatively poorly in a stationary state and conventional vehicle cameras require motion of the vehicle in order to measure distance. Furthermore, in a stationary state, vehicle localisation is limited to only a “snapshot” of information from a single point of view of the vehicle relative to its environment. This can introduce additional inaccuracies in a planned manoeuvre, thereby limiting performance of automated parking. Additionally, in some environments, such as where information or features are limited, or there is too much symmetry, static localisation may fail to completely localisation the vehicle, meaning the automated parking and low speed manoeuvre will not proactively be activated and may fail to start operating.

Attempts to overcome the aforementioned problems comprise using environmental sensors on board the vehicle to continuously localise the vehicle, whilst it is stationary and prior to starting a low speed manoeuvre, such as parking, with high precision throughout vehicle operation, or at least whilst the vehicle is in motion. Such attempts involve the use of expensive sensors, which may have limited sensing capabilities. Continuous localisation involves high consumption of power and memory and is particularly processor heavy. Furthermore, the level of accuracy obtainable from continuous localisation methods may not necessarily be required throughout the duration of many highway driving scenarios, rendering continuous localisation methods highly inefficient.

An additional challenge relating to realising autonomous parking and low speed manoeuvres features comprises recognising a parking area and starting to localise the vehicle inside the parking area. This may involve extensive searching of a memory for a relevant area map relating to the parking area.

It is an object of embodiments of the invention to at least mitigate one or more of the problems of the prior art.

### SUMMARY OF THE INVENTION

Aspects and embodiments of the invention provide a method, an apparatus, a system and a vehicle, as claimed in the appended claims.

According to an aspect of the invention, there is provided a method for proactively localising a vehicle, the method comprising:
a. determining that the vehicle is approaching an end of a journey;
b. localising the vehicle in dependence on said determining.

Advantageously, this enables the vehicle to initiate a high precision localisation process prior to the vehicle reaching the end of the journey. By proactively localising the vehicle, accurate knowledge of vehicle initial position can be obtained as soon as the vehicle stops, meaning that any delay between a user requesting the vehicle to perform an automated parking or automated low speed manoeuvre or to provide instructions for the user as to how to manually perform said manoeuvre, and the vehicle carrying out said manoeuvre or providing said instructions is minimised, if not eliminated. Furthermore, said localising may therefore be performed whilst the vehicle is still in motion, advantageously increasing the availability of information from multiple points of view of the vehicle relative to its environment and increases the performance of numerous sensing means on the vehicle. This helps to minimise, if not eliminate, additional inaccuracies in a planned manoeuvre, such as a parking manoeuvre, thereby increasing performance and user experience of a parking event. By localising the vehicle in dependence on said determining, sensing means associated with the vehicle need not be continuously unnecessarily performing high precision localisation throughout operation of the vehicle. This advantageously minimises consumption of power and memory, is less processor heavy and is more efficient, as compared to prior art methods. The method also improves comfort of a user or users of the vehicle by avoiding unpredictable movement, such as initiating an automated manoeuvre, once the vehicle reaches a parking location, for dynamic localization to identify initial position. This may be useful when localising vehicle in stationary state fails.

According to an aspect of the invention, there is provided a method for proactively localising a vehicle, the method comprising:
a. determining that the vehicle is approaching an end of a journey;
b. sensing one or more features of an environment proximal to the vehicle; and
c. upon determining that the vehicle is approaching the end of the journey, localising the vehicle in dependence on said sensing.

Advantageously, this enables the vehicle to initiate a high precision localisation process prior to the vehicle reaching the end of the journey. By proactively localising the vehicle, accurate knowledge of vehicle initial position can be obtained as soon as the vehicle stops, meaning that any delay between a user requesting the vehicle to perform an automated parking manoeuvre or to provide instructions for the user as to how to manually perform said manoeuvre, and the vehicle carrying out said manoeuvre or providing said instructions is minimised, if not eliminated. Furthermore, said localising may therefore be performed whilst the vehicle is still in motion, advantageously increasing the availability of information from multiple points of view of the vehicle relative to its environment. This helps to minimise, if not eliminate, additional inaccuracies in a planned manoeuvre, such as a parking manoeuvre, thereby increasing performance and user experience of a parking event. By localising the vehicle in dependence on said determining, sensing means associated with the vehicle need not be continuously unnecessarily performing high precision localisation throughout operation of the vehicle. This advantageously minimises consumption of power and memory, is less processor heavy and is more efficient, as compared to prior art methods. The method also improves comfort of a user or users of the vehicle by avoiding unpredictable movement once the vehicle reaches a parking location, for dynamic localization to identify initial position.

In some embodiments, the method comprises, prior to said sensing, activating, in dependence on said determining, at least one sensing means associated with the vehicle. In some embodiments, sensing means need not be activated prior to said sensing. This advantageously minimises consumption of power and memory, is less processor heavy and is more efficient, as compared to prior art methods.

In some embodiments, the sensing means may be arranged to receive radiation from the environment proximal to the vehicle. Advantageously, this enables localisation of the vehicle even in areas in which GPS coverage is not always available, such as in roofed or underground car parks, or in a high density urban environment.

In some embodiments, the sensing means comprises one or more of: RADAR, LIDAR, one or more ultrasound sensors and one or more cameras. Advantageously, such sensing means are able to localise the vehicle with a high precision, even in areas in which GPS coverage is not always available, such as in roofed or underground car parks, or in a high density urban environment.

In some embodiments, said determining that the vehicle is approaching an end of a journey comprises comparing a location of the vehicle with a predetermined location. Advantageously, this enables the confirmation that the vehicle is indeed approaching the end of the journey. In some embodiments, said comparing may comprise determining whether one or more predetermined landmarks are present. This may optionally be done in dependence on detecting a reduction in vehicle speed. Advantageously, this is a simple, yet reliable way of confirming that the vehicle is indeed approaching the end of the journey.

In some embodiments, the predetermined location comprises a location of a parking area or an area in which the vehicle may perform a low speed manoeuvre.

In some embodiments, said localising is initiated when said comparing determines that the vehicle location is a predetermined distance from the predetermined location. Advantageously, said localising is only initiated towards the end of the journey of the vehicle, meaning that sensing means associated with the vehicle need not be continuously unnecessarily performing high precision localisation throughout operation of the vehicle and may instead be employed pre-emptively. This advantageously minimises consumption of power and memory, is less processor heavy and is more efficient, as compared to prior art methods.

In some embodiments, said predetermined distance may be 100 metres. In some embodiments, said predetermined distance may be less than 100 metres. In some embodiments, said predetermined distance may be between 20 and 30 metres. In some embodiments, said predetermined distance may be less than 20 metres.

In some embodiments, the method comprises verifying that a location of the vehicle substantially corresponds to the predetermined location. Advantageously, this enables verification of the parking location, which helps to ensure that a correct map is chosen to localise the vehicle. This helps to avoid or at least minimise extensive searching of a memory means for the correct map to use.

In some embodiments, said determining that the vehicle is approaching an end of a journey comprises determining a reduction in vehicle speed. In some embodiments, this may be done in combination with said detecting that one or more landmarks are present. Advantageously, this is a simple, yet reliable way of confirming that the vehicle is indeed approaching the end of the journey.

In some embodiments, said determining that the vehicle is approaching an end of a journey comprises determining whether one or more predetermined landmarks are present. Advantageously, this enables proactive localisation of the vehicle even in areas in which GPS coverage is not always available, such as when the vehicle enters a roofed or underground car park. Said predetermined landmarks may be stored in a memory means, such as a non-transitory computer readable memory device associated with the vehicle or on a cloud based server. Said predetermined landmarks may be stored in one or more high definition (HD) maps. Said one or more HD maps may be stored on a memory means, such as a non-transitory computer readable memory device associated with the vehicle or on a cloud based server. In some embodiments, said determining whether one or more predetermined landmarks are present comprises activating an on board camera, such as a mono-camera or a stereo-camera.

In some embodiments, the term landmarks may comprise road signs. In some embodiments, the memory means may store one or more images associated with a known location, such as an image of an entrance to a known parking location. In some embodiments, the method may comprise activating sensing means, such as a sensor, associated with the vehicle in dependence on the detection of a substantially similar image to one stored in the memory means. In some embodiments, said memory means and/or said HD maps may comprise a variety of information relating to public areas, such as GPS coordinates, information regarding landmarks, road types and live traffic. Advantageously, this can determine whether the vehicle is in a residential area and can be used to proactively initiate said localising.

In some embodiments, said determining that the vehicle is approaching an end of a journey comprises detecting a network, a local area network, or a wireless local area network, such as a WIFI network. The WIFI network, in some embodiments, may be a home WIFI network or a workplace WIFI network. Advantageously, this enables proactive localisation to be triggered as the vehicle approaches a known location, such as a home of a user or a place of work of the user.

In some embodiments, said determining that the vehicle is approaching an end of a journey comprises receiving a user initiated signal. In some embodiments, said user initiated signal may be a signal initiated upon depression of a button by a user, or may be a voice command of the user. Advantageously, this enables the user to signal when they are approaching the parking area, which ensures proactive localisation is commenced in time to avoid any delay that might otherwise be observed if the vehicle were to come to a stop prior to performing a parking manoeuvre, such as in the event that the method failed to determine that the vehicle was approaching the end of the journey.

In some embodiments, said localising comprises comparing said one or more features of the environment proximal to the vehicle with one or more predetermined features. In some embodiments, said one or more predetermined features may be stored in a memory means, such as a non-transitory computer readable memory device associated with the vehicle or on a cloud based server.

In some embodiments, said localising occurs whilst the vehicle is still in motion. Advantageously, this facilitates said localising as some sensing means, such as cameras, RADAR, LIDAR, associated with the vehicle operate better when the vehicle is in motion. This also advantageously increases the availability of information from multiple points of view of the vehicle relative to its environment. This helps to minimise, if not eliminate, additional inaccuracies in a planned manoeuvre, such as a parking manoeuvre, thereby increasing performance and user experience of a parking event.

In some embodiments, the method comprises providing a user with a prompt querying whether the user would like to proceed with a parking manoeuvre. In some embodiments, if the user responds positively, indicating that they would indeed like to proceed, the method may comprise determining a manoeuvre for the vehicle to reach a target parking position; and initiating said manoeuvre. Alternatively, in some embodiments, if the user responds positively, indicating that they would indeed like to proceed, the method may comprise providing the user with instructions as to how to perform the parking manoeuvre. Advantageously, this enables the method to pre-empt a user action and also enables the user to override the method if desired.

Optionally, said prompt is provided upon determination that the vehicle has stopped. Optionally, said prompt if provided upon determination that the vehicle has stopped and a location has been confirmed as being one or said one or more predetermined locations. In some embodiments, the term ‘stopped’ may comprise the vehicle being substantially static for a minimum period of time. Alternatively, said prompt may be provided upon entry of the vehicle in a known parking area.

In some embodiments, said manoeuvre may be initiated by activating one or more on board inertial measurement units (IMU), such one or both of one or more accelerometers and one or more gyroscopes. Alternatively, said one or more IMUs may be activated prior to initiating manoeuvre and used in combination with sensing means associated with the vehicle, after said localising is proactively triggered to improve accuracy of said localising. Said one or more IMUs may also be used approximate a vehicle position in a journey, such as in an event wherein a GPS or dGPS signal is briefly lost.

According to another aspect of the invention, there is provided computer software which, when executed by a computer, is arranged to perform a method as above described.

According to another aspect of the invention, there is provided a non-transitory computer readable medium having computer readable instructions stored thereon which, when executed by a computer, perform a method according to the aspect of the invention as above described.

According to another aspect of the invention, there is provided an apparatus for proactively localising a vehicle, the apparatus comprising:
a. means for receiving one or more signals indicative of a position in a journey of the vehicle;
b. processing means for determining, in dependence on said one or more signals, whether the vehicle is approaching an end of a journey; and
c. sensing means for sensing one or more features of an environment proximal to the vehicle;
d. wherein the processing means is arranged to initiate a localisation of the vehicle in dependence on said sensed features, upon determining that the vehicle is approaching the end of the journey.

Advantageously, this enables the apparatus to initiate a high precision localisation process prior to the vehicle reaching the end of the journey. By proactively localising the vehicle, accurate knowledge of vehicle initial position can be obtained as soon as the vehicle stops, meaning that any delay between a user requesting the vehicle to perform an automated parking manoeuvre or to provide instructions for the user as to how to manually perform said manoeuvre, and the vehicle carrying out said manoeuvre or providing said instructions is minimised, if not eliminated. Furthermore, said processing means may be arranged to initiate said localisation whilst the vehicle is still in motion, advantageously increasing the availability of information from multiple points of view of the vehicle relative to its environment. This helps to minimise, if not eliminate, additional inaccuracies in a planned manoeuvre, such as a parking manoeuvre, thereby increasing performance and user experience of a parking event. Advantageously, the sensing means associated with the vehicle need not be continuously unnecessarily performing high precision localisation throughout operation of the vehicle, which minimises consumption of power and memory, is less processor heavy and is more efficient, as compared to prior art apparatuses.

In some embodiments, the processing means is arranged to, prior to said sensing, activate, in dependence on said one or more signals, said sensing means associated with the vehicle. In some embodiments, said sensing means need not be activated prior to said sensing. This advantageously minimises consumption of power and memory, is less processor heavy and is more efficient, as compared to prior art methods.

In some embodiments, the sensing means may be arranged to receive radiation from the environment proximal to the vehicle. Advantageously, this enables localisation of the vehicle even in areas in which GPS coverage is not always available, such as in roofed or underground car parks, or in a high density urban environment.

In some embodiments, the sensing means comprises one or more of: RADAR, LIDAR, one or more ultrasound sensors and one or more cameras. Advantageously, such sensing means are able to localise the vehicle with a high precision.

In some embodiments, said at least one signal comprises a signal indicative of a location of the vehicle. In some embodiments, said signal indicative of a location of the vehicle comprises a GPS signal or a dGPS signal. In some embodiments, said at least one signal indicative of a location of the vehicle comprises a WIFI signal.

Optionally, said processing means is arranged to compare said signal indicative of a location of the vehicle with an expected signal associated with one or more predetermined locations. The one or more predetermined locations may comprise one or more parking locations. In some embodiments, said expected signal may comprise a known GPS position of the predetermined location. Advantageously, this enables confirmation that the vehicle is indeed approaching the end of the journey. In some embodiments, said comparing may comprise determining whether one or more pre-determined landmarks are present. This may optionally be done in dependence on detecting a reduction in vehicle speed. Advantageously, this is a simple, yet reliable way of confirming that the vehicle is indeed approaching the end of the journey.

In some embodiments, the predetermined location comprises a location of a known parking area.

In some embodiments, said comparing comprises determining whether the vehicle is within a predetermined distance from the one or more predetermined locations.

Advantageously, said localisation is only initiated towards the end of the journey of the vehicle, meaning that said sensing means need not be continuously unnecessarily performing high precision localisation throughout operation of the vehicle and may instead be employed pre-emptively. This advantageously minimises consumption of power and memory, is less processor heavy and is more efficient, as compared to prior art methods.

In some embodiments, said at least one signal comprises a signal indicative of a reduction in vehicle speed. Advantageously, this is a simple, yet reliable way of confirming that the vehicle is indeed approaching the end of the journey.

In some embodiments, said at least one signal comprises a signal indicative of a presence of one or more predetermined landmarks. Advantageously, this is a simple, yet reliable way of confirming that the vehicle is indeed approaching the end of the journey. This also advantageously, enables proactive localisation of the vehicle even in areas in which GPS coverage is not always available, such as when the vehicle enters a roofed or underground car park. Said predetermined landmarks may be stored in a memory means, such as a non-transitory machine readable memory device associated with the vehicle or on a cloud based server. Said predetermined landmarks may be stored in one or more HD maps. Said one or more HD maps may be stored on a memory means, such as a non-transitory machine readable memory device associated with the vehicle or on a cloud based server. In some embodiments, the term landmarks may comprise road signs. In some embodiments, the memory means may store one or more images associated with a known location, such as an image of an entrance to a known parking location. In some embodiments, said memory means and/or said HD maps may comprise a variety of information relating to public areas, such as GPS coordinates, information regarding landmarks, road types and live traffic. Advantageously, this can determine whether the vehicle is in a residential area and can be used to proactively initiate said localising.

In some embodiments, said at least one signal comprises an electronic signal initiated by depression of a button or a signal initiated by an audio command provided by a user. In some embodiments, said user initiated signal may be a signal initiated upon depression of a button by a user, or may be a voice command of the user. Advantageously, this enables the user to signal when they are approaching the parking area, which ensures proactive localisation is commenced in time to avoid any delay that might otherwise be observed if the vehicle were to come to a stop prior to performing a parking manoeuvre, such as in the event that the method failed to determine that the vehicle was approaching the end of the journey.

In some embodiments, the apparatus comprises a memory means, such as a non-transitory machine readable memory device, or a cloud based server.

In some embodiments, the apparatus comprises means for accessing information stored on a cloud based server. In some embodiments, said information may comprise any one or more of: one or more HD maps, landmark information, terrain information, one or more GPS positions, a layout or layouts of one or more parking areas, one or more desirable parking spaces within one or more parking areas.

In some embodiments, the apparatus comprises one or more on board IMUs.

In some embodiments, the apparatus comprises output means. In some embodiments, said output means is arranged to output a signal for controlling one or more vehicle systems in dependence on said localisation of the vehicle. In some embodiments, said output means is arranged to output a signal for providing a user with a prompt querying whether the user would like the vehicle to proceed performing a low speed manoeuvre, such as a low speed parking manoeuvre. Advantageously, this enables the method to pre-empt a user action and also enables the user to override the method if desired.

In some embodiments, said output means is arranged to output said signal for providing a user with a prompt upon determination that the vehicle has stopped.

In some embodiments, said processing means is arranged to output said signal for providing a user with a prompt upon entry of the vehicle in a known parking area.

According to another aspect of the invention, there is provided an apparatus for proactively localising a vehicle, the apparatus comprising:
a. an input for receiving one or more signals indicative of a position in a journey of the vehicle;
b. a processor for determining, in dependence on said one or more signals, whether the vehicle is approaching an end of a journey; and
c. one or more sensors for sensing one or more features of an environment proximal to the vehicle;
d. wherein the processor is arranged to initiate a localisation of the vehicle in dependence on said sensed features, upon determining that the vehicle is approaching the end of the journey.

Advantageously, this enables the apparatus to initiate a high precision localisation process prior to the vehicle reaching the end of the journey. This minimises, if not eliminates any delay between a user requesting the vehicle to perform an automated parking manoeuvre or to provide instructions for the user as to how to manually perform said manoeuvre, and the vehicle carrying out said manoeuvre or providing said instructions. Furthermore, said processor may be arranged to initiate said localisation whilst the vehicle is still in motion, advantageously increasing the availability of information from multiple points of view of the vehicle relative to its environment. This helps to minimise, if not eliminate, additional inaccuracies in a planned manoeuvre, such as a parking manoeuvre, thereby increasing performance and user experience of a parking event. Advantageously, the one or more sensors associated with the vehicle need not be continuously unnecessarily performing high precision localisation throughout operation of the vehicle, which minimises consumption of power and memory, is less processor heavy and is more efficient, as compared to prior art apparatuses.

According to another aspect of the invention, there is provided an electronic system comprising the apparatus substantially as above described.

According to still another aspect of the invention, there is provided a vehicle comprising the apparatus substantially as above described, or an electronic system comprising the apparatus substantially as above described.

As used herein, the terms “localisation”, “localising” or “localise” may refer to at least identifying a position and/or an orientation of a vehicle relative to its surroundings. The location may be a known location. The surroundings may be an environment proximal to the vehicle, such as within a 10 metre radius or more.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a method for localising a vehicle in accordance with an embodiment of the invention;

FIG. 2 shows an apparatus for localising a vehicle in accordance with an embodiment of the invention;

FIG. 3 shows a vehicle in accordance with an embodiment of the invention; and

FIG. 4 shows a schematic illustration of an embodiment of the present invention.

### DETAILED DESCRIPTION

A method for proactively localising a vehicle comprises determining that the vehicle is approaching an end of a journey, sensing one or more features of an environment proximal to the vehicle, and upon determining that the vehicle is approaching the end of the journey, localising the vehicle in dependence on said sensing.

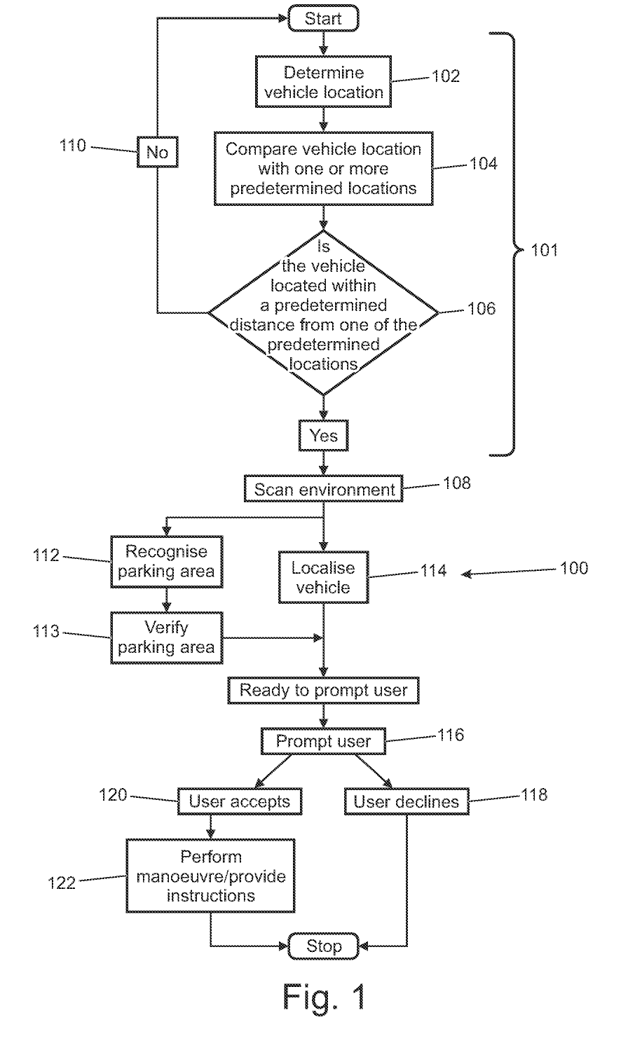

FIG. 1 shows a method 100 according to an embodiment of the invention. Determining 101 that the vehicle is approaching an end of a journey may be achieved in a variety of ways. In the embodiment illustrated in FIG. 1, said determining 101 that the vehicle is approaching the end of the journey comprises determining a location of the vehicle 102 and comparing 104 said location of the vehicle with a predetermined location, such as a location of a parking area. Comparing the location of the vehicle with the predetermined location may comprise comparing a vehicle GPS reading with a GPS position of the predetermined location. When it is determined 106 that the GPS position of the vehicle is a predetermined distance from the GPS position of the predetermined location, it may be determined that the vehicle is approaching the end of the journey and localisation of the vehicle may be initiated 108. If it is determined 110 that the vehicle is not within a predetermined distance from the GPS position of the predetermined location, it may be determined that the vehicle is not approaching the end of the journey and localisation of the vehicle is not initiated. The predetermined distance may be 100 metres or more, or in some embodiments, 30 metres or less. Information relating to the predetermined location, such as GPS coordinates, may be stored in a memory means, such as a non-transitory computer readable medium associated with the vehicle, or on a cloud based server accessible by one or more systems associated with the vehicle. It will be appreciated that dGPS or other suitable location tracking methods may be used to determine that the vehicle is approaching the end of the journey. In some embodiments, the method comprises assessing a direction of travel of the vehicle for determining whether the vehicle is on route to the predetermined location, or is merely passing the location.

Although GPS or the like may be used to trigger 108 localisation or at least to determine 101 that the vehicle is approaching the end of the journey, the method does not necessarily rely on the use of GPS. In some embodiments, determining that the vehicle is approaching an end of a journey comprises determining a reduction in vehicle speed. Alternatively or additionally, determining that the vehicle is approaching an end of a journey comprises determining whether one or more predetermined landmarks are present. In some embodiments, determining that the vehicle is approaching an end of a journey comprises determining whether one or more predetermined landmarks are present in dependence on detecting a reduction in vehicle speed. The term “landmarks” as used herein may comprise road signs, buildings or structures in a public area, or other known features or attributes relating to an area or to at least a visual appearances of an area. Landmarks may be detected by sensing means associated with the vehicle, such as one or more on board sensors, or sensing systems. The sensing means may comprise one or more on board cameras for detecting landmarks in an environment proximal to the vehicle. Detected landmarks in an environment of the vehicle may be compared with information relating to a predetermined location, such as a parking location. Information relating to one or more predetermined locations may be stored in a memory means, such as a non-transitory computer readable medium associated with the vehicle, or on a cloud based server accessible by one or more systems associated with the vehicle. Such information may include images or photographs. Additionally or alternatively, such information may comprise retrievable information stored in one or more HD maps. Third party HD electronic maps are now widely available and indeed are often used in the field of autonomous driving. Information stored in HD maps may comprise a variety of information relating to public areas, such as GPS coordinates, information regarding landmarks, road types and live traffic. The one or more HD maps may be stored in a memory means, such as a non-transitory computer readable medium associated with the vehicle, or on a cloud based server accessible by one or more systems associated with the vehicle.

In some embodiments, it may be determined that the vehicle is approaching the end of a journey by receiving a user initiated signal. The user initiated signal may be initiated upon depression of a button or by means of a voice command. In this way, the user may initiate such a signal when they know that the vehicle is approaching an end of their journey.

When it is determined 101 that the vehicle is approaching an end of the journey, the method comprises localising the vehicle 114, for determining an initial position of the vehicle prior to determining or performing a manoeuvre, such as a low speed automated parking manoeuvre. A map of a parking area may be readily available. The map may comprise a retrievable map stored on a memory means, such as a non-transitory computer readable medium associated with the vehicle, or on a cloud based server accessible by one or more systems associated with the vehicle. Such maps may be uploaded by the user to a cloud based server. The uploaded map may be shared with other users. Maps uploaded by other users may likewise be shared, such that a user has access to a number of maps which may be downloaded directly from the cloud based server. In some embodiments, one or more maps may additionally or alternatively be provided by a third party service provider, such as a map and/or navigation service company.

The map may be built by a driver teaching the vehicle the parking area in an initial mapping process. The map may be built by the driver teaching the vehicle 114 a parking area or manoeuvre area in an independent mapping process by driving around the parking area or manoeuvre area to provide guidance to the vehicle 114. Whilst, the driver drives around the parking or manoeuvre area, one or more sensing means, such as one or more on-board vehicle sensors scan at least a part of the parking or manoeuvre area to gradually build a map of the scanned area, optionally including landmarks, features or environmental attributes, for enabling later localisation and automated manoeuvring of the vehicle 114.

Localisation 114 of the vehicle is, in some embodiments, initiated 108 whilst the vehicle is still in motion, such as when the vehicle is approaching or entering the parking area. Conditions for commencing localisation, such as environmental conditions, may be evaluated prior to initiating 108 localisation 114. Sensing means, such as one or more cameras, ultrasound sensors, RADAR and LIDAR are arranged to sense one or more features of an environment proximal to the vehicle to localise 114 the vehicle. Such features may comprise, amongst other things, relative distance measurements between the vehicle and objects or obstacles proximal to the vehicle. Relative distance measurements are obtainable by the sensing means scanning the environment. During this period of localisation 114, until the vehicle stops inside the parking area, the sensing means may operate to dynamically localise 114 the vehicle with improved accuracy and reliability. In this way, more information is available for consideration during localisation 114 of the vehicle, as compared to a conventional static localisation method. By proactively localising 114 the vehicle in a dynamic state, accurate knowledge of vehicle initial position can be obtained as soon as the vehicle stops, meaning that the vehicle is ready to perform a manoeuvre, such as a low speed autonomous manoeuvre, or to provide instructions to a user as to how to manually perform a manoeuvre. The method may comprise continuing vehicle localisation 114 during at least part of a manoeuvre, such as a low speed autonomous parking manoeuvre.

In addition to localising 114 the vehicle, the method, in some embodiments, comprises recognising 112 the parking area and optionally verifying 113 that the recognised parking area is indeed the parking area within which the vehicle is located, in dependence on said determining 101 that the vehicle is approaching the end of the journey. This may ensure that a correct map is chosen for manoeuvring within the parking area. The method may comprise initially recognising 112 a known area based on, in some embodiments, a GPS position of the vehicle, before continuing to verify 113 the area based on, in some embodiments, one or more sensed features, such as observed scenes, as the vehicle enters the area. The method need not necessarily verify the entire parking area and may cease said verifying once a high confidence in the recognised area is obtained. Verifying 113 the parking area may comprise comparing information relating to one or more predetermined parking locations with information, such as sensed information, relating to an environment proximal to the vehicle. Verifying 113 the parking area may comprise comparing information relating to one or more entrances to one of said predetermined parking locations with sensed information relating to the environment proximal to the vehicle. Said recognising 112 and verifying 113 may be performed prior to or in parallel with localising 114 the vehicle. When performed in parallel with localising 114 the vehicle, said localising 114 may proceed with a relatively low vehicle speed for at least comfort purposes, or may be controlled by a driver.

Information relating to one or more predetermined parking locations or entrances thereto may be stored in a memory means, such as a non-transitory computer readable medium associated with the vehicle, or on a cloud based server accessible by one or more systems associated with the vehicle. Such information may include images or photographs. Such information may additionally or alternatively comprise retrievable information stored in one or more HD maps. Information stored in HD maps may be stored in a memory means, such as a non-transitory computer readable medium associated with the vehicle, or on a cloud based server accessible by one or more systems associated with the vehicle. In some embodiments, recognising the parking area comprises matching sensed environmental information, such as observed landmarks, with information, such as landmark information, stored in HD maps. In this way, the method enables verification of the parking location. This helps to ensure that a correct map is chosen to determine an initial position of the vehicle during said localisation 114 and that a correct map is used for determining any subsequent manoeuvres, such as a low speed autonomous parking manoeuvre.

With the proactive initiation 108 of localisation 114 and optionally the recognition 112 and verification 113 of a parking area whilst the vehicle is in motion, the method enables an initial position of the vehicle to be determined, and optionally tracked, to a high precision and accuracy, prior to performing a low speed manoeuvre, such as a low speed automated parking manoeuvre.

The method 100 comprises, after at least initiating 108 said localising 114, providing 116 a user with a prompt querying whether the user would like to proceed with a manoeuvre, such as a parking manoeuvre. The prompt may be provided 116 when it is determined that the vehicle has stopped 101 and in some embodiments, may not be provided until said localising 114 has at least been initiated. In this way, when the prompt is provided to the user, the method 100 has already optionally recognised 112 and optionally verified 113 the area and has good knowledge of its initial position due to the localisation 114 of the vehicle. The prompt may be provided 116 upon entry of the vehicle in a known parking area. In response to the user's confirmation 120 that they would indeed like to proceed, the method 100 may comprise performing the manoeuvre 122, such as parking, autonomously and immediately, without any or with little delay, compared to conventional methods. Alternatively, in response to the user's confirmation 120 that they would like to proceed, the method 100 may comprise providing the user with instructions 122 immediately, without any or with little delay, as to how to manually perform the manoeuvre themselves. The method 100 may comprise continuing to localise 114 the vehicle throughout part or all of the manoeuvre. In some embodiments, one or more inertial measurement units (IMU) or other motion sensors associated with the vehicle or on board the vehicle may assist with the manoeuvre. Alternatively, the user may decline 118 the prompt, in which case no action is taken.

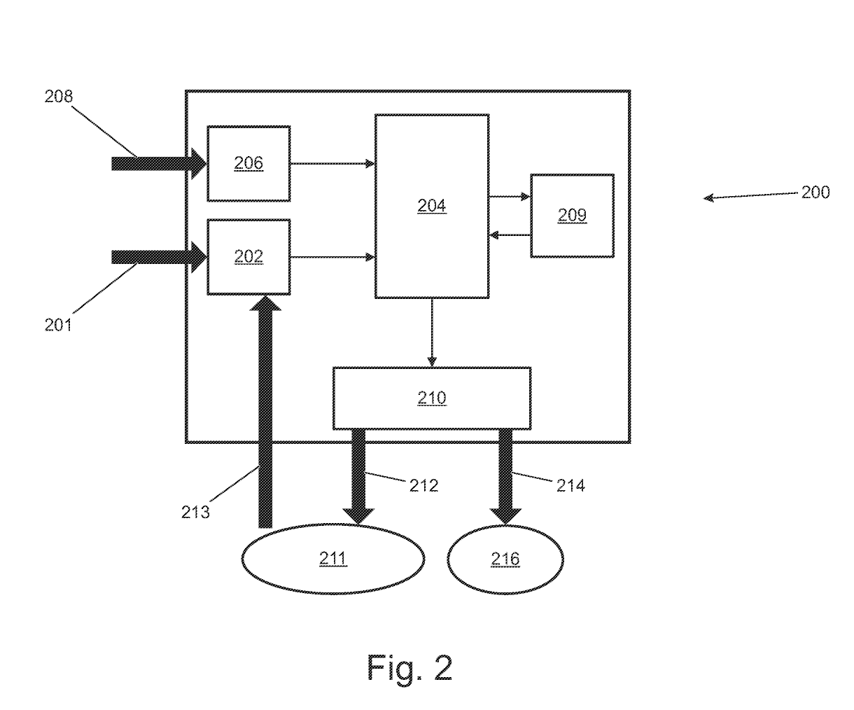

FIG. 2 shows an apparatus 200 for proactively localising a vehicle, according to an embodiment of the invention. In the embodiment illustrated in FIG. 2, the apparatus 200 comprises means, such as an input 202, for receiving one or more signals 201 indicative of a position in a journey of the vehicle, processing means, such as a processor 204, for determining, in dependence on said one or more signals 201, whether the vehicle is approaching an end of a journey and sensing means 206, such as one or more sensors, for sensing one or more features 208 of an environment proximal to the vehicle. The processing means 204 is arranged to localise the vehicle in dependence on said sensed features 208, upon determining that the vehicle is approaching the end of the journey.

Said sensing means 206 may comprise one or more sensors or sensor systems associated with or on board the vehicle. The sensing means 206 may be arranged to receive radiation and may comprise any one or more of: RADAR, LIDAR, an ultrasound sensor and a camera. In some embodiments, the sensing means 206 is activated in dependence on the processing means 204 determining that the vehicle is approaching the end of the journey. Alternatively, the sensing means 206 may always be activated, at least whilst electronics of the vehicle are switched on. In some embodiments, the sensing means 206 may always be activated, at least whilst electronics of the vehicle are switched on, but may enter an environment scanning mode in dependence on the processing means 204 determining that the vehicle is approaching the end of the journey.

The one or more signals 201 may comprise a signal indicative of a location of the vehicle, such as a GPS signal of the vehicle. The processing means 204 may be arranged to compare said signal 201 indicative of a location of the vehicle with an expected signal, such as a known GPS position, of one or more predetermined locations, such as parking locations. In some embodiments, the processing means 204 is arranged to determine that the vehicle is approaching the end of the journey when the processing means 204 determines that the location of the vehicle is a predetermined distance from the location of a predetermined location. The predetermined distance may be 100 metres or less, or in some embodiments, 30 metres or less.

The one or more signals 201 may comprise one or both of a signal indicative of a reduction in vehicle speed and a signal indicative of the presence of one or more landmarks. The term “landmarks” as used herein may comprise road signs, buildings or structures in a public area, or other known features or attributes relating to an area or to at least a visual appearances of a public area. Landmarks may be detected by the sensing means 206. The processing means 204 may be arranged to detect landmarks in an environment of the vehicle and to compare the detected landmarks with information relating to a predetermined location, such as a parking location.

The one or more signals 201 may comprise a user initiated signal, which may be an electronic signal. The user initiated signal may be initiated upon depression of a button or by means of a voice command. In this way, the user may initiate such a signal 201 when they know that the vehicle is approaching an end of their journey.

The processing means 204 is arranged to localise the vehicle upon determining that the vehicle is approaching the end of the journey. The processing means 204 may be arranged to initiate localisation of the vehicle whilst the vehicle is still in motion, such as when the vehicle is approaching or entering a parking area. The apparatus 200 may be arranged to evaluate environmental conditions, such as safety conditions, prior to initiating localisation of the vehicle. The processing means 204 is arranged to localise the vehicle in dependence on one or more features 208 of an environment proximal to the vehicle sensed by said sensing means 206. Such features of an environment may comprise, amongst other things, relative distance measurements between the vehicle and objects or obstacles proximal to the vehicle. Relative distance measurements may be obtainable by the sensing means 206 scanning the environment. During this period of localisation, until the vehicle stops inside the parking area, the sensing means 206 may operate to localise the vehicle with improved accuracy and reliability. In this way, more information is available for consideration during localisation of the vehicle, as compared to a conventional static localisation method. The processor 204 may be arranged to dynamically localise the vehicle, whilst the vehicle is still in motion. By proactively localising the vehicle in a dynamic state, accurate knowledge of vehicle initial position can be obtained as soon as the vehicle stops, meaning that the vehicle is ready to perform a manoeuvre, such as a low speed autonomous manoeuvre, or to provide instructions to a user as to how to manually perform a manoeuvre. The processing means 204 may be arranged to continue localising the vehicle during at least part of a manoeuvre, such as a low speed autonomous parking manoeuvre.

The processing means 204 may additionally be arranged to recognise the parking area in dependence on determining that the vehicle is approaching the end of the journey. This may be achieved, in some embodiments, by the processing means 204 comparing a signal 201 indicative of a GPS reading of the vehicle with a known GPS position of the parking location. The processing means 204 may additionally be arranged to verify that the recognised parking area is indeed the parking area which the processing means 204 has recognised. This may ensure that a correct map is chosen for manoeuvring in the parking area. The processing means 204 need not necessarily verify the entire parking area and may be arranged to cease said verifying once a high confidence in the recognised area is obtained. The processing means 204 may be arranged to verify the parking area by comparing one or more signals 208 indicative of information relating to one or more predetermined parking locations with information relating to an environment proximal to the vehicle. Verifying 113 the parking area may comprise comparing information relating to one or more entrances to one of said predetermined parking locations with sensed information relating to the environment proximal to the vehicle. Said information may be sensed by the sensing means 206. In some embodiments, the processing means 204 is arranged to recognise and optionally verify the parking area in parallel with or prior to localising the vehicle. When performed in parallel with localising the vehicle, the processing means 204 may be arranged to proceed with localising only when the vehicle is travelling at a relatively low vehicle speed, for at least comfort purposes.

The apparatus 200 may comprise an output means, such as an output 210, arranged to output a signal 212 for providing a user 211 with a prompt querying whether the user would like the vehicle to proceed with a manoeuvre, such as a parking manoeuvre. The output means 210 may be arranged to output the prompt signal 212 when the processing means 204 determines that the vehicle has stopped in a parking area. The output of the prompt signal 212 may be inhibited until the processing means 204 has at least started said localising of the vehicle. In this way, when the prompt is provided to the user 211, the processing means 204 has already recognised and optionally verified the parking area and has good knowledge of the vehicle's initial position due to the localisation of the vehicle, meaning that there is little to no computational delay between a user accepting the prompt and the vehicle performing a manoeuvre.

In some embodiments, the output means 210 is arranged to output the prompt signal 212 when the processing means 204 determines that the vehicle has entered a known parking area. The input means 202 may be arranged to receive a signal 213 indicative of the user's confirmation that they would indeed like to proceed with the manoeuvre. The apparatus 200 may be arranged so that, in dependence on the input means 202 receiving the signal 213, the processing means 204 controls the output means 210 to output a signal 214 to control one or more systems 216 associated with the vehicle to autonomously perform the manoeuvre. Alternatively, the signal 214 may control one or more systems 216 associated with the vehicle to provide the user with instructions as to how to manually perform the manoeuvre themselves. The signal 214 may be output immediately upon receipt of the user's confirmation 213, without any or with only little delay. The processing means 204 may be arranged to continue to localise the vehicle throughout part or all of the manoeuvre, whether performed manually or autonomously. One or more inertial measurement units (IMU) or other motion sensors associated with the vehicle or on board the vehicle may assist with the manoeuvre.

In some embodiments, the apparatus 200 comprises a memory means 209, such as a non-transitory computer readable medium associated with the vehicle. The memory means 209 may store information relating to one or more predetermined locations, such as one or more of: GPS coordinates, photographs, landmark details, road types, layouts of parking areas and desirable parking spaces within the areas. Information relating to one or more predetermined parking locations or entrances thereto may be stored in the memory means 209. The memory means 209 may store one or more HD maps, which HD maps may store a variety of information relating to public areas, such as GPS coordinates, information regarding landmarks, road types and live traffic.

Alternatively or additionally, the apparatus 200 may comprise means for accessing information stored on a cloud based server. The cloud based server may store information relating to one or more predetermined locations, such as one or more of: GPS coordinates, photographs, landmark details, road types, layouts of parking space and desirable parking spaces within the area. Information relating to one or more predetermined parking locations or entrances thereto may be stored on the cloud based server. The cloud based server may store one or more HD maps, which HD maps may store a variety of information relating to public areas, such as GPS coordinates, information regarding landmarks, road types and live traffic.

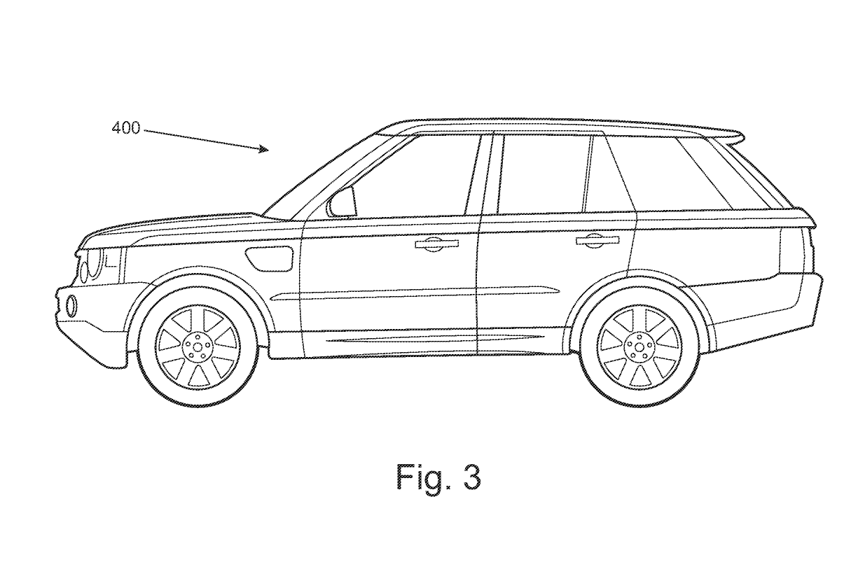

Other embodiments of the invention relate to an electronic system comprising an apparatus as described. FIG. 3 shows an embodiment in which a vehicle 400 comprises an apparatus 200.

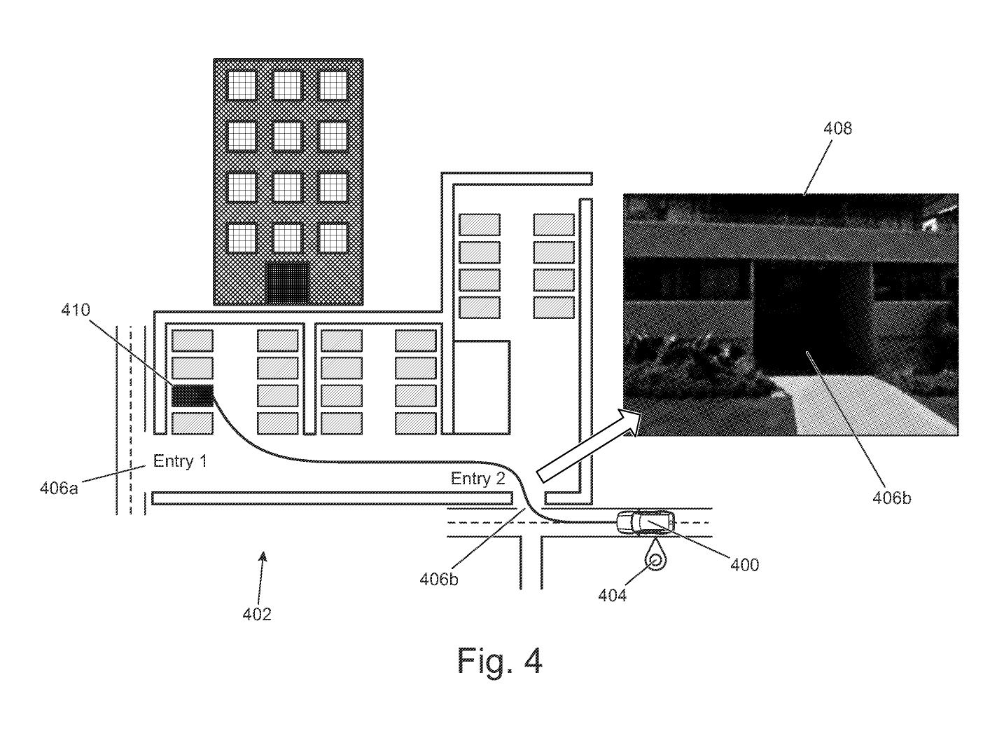

FIG. 4 shows a schematic illustration of an embodiment of the present invention. As a vehicle 400 approaches a known parking area 402, processing means 204 determines, based on a GPS reading of the vehicle, that the vehicle's location 404 is within a predetermined distance, such as within 30 metres, of the parking area 402. The processing means 204 therefore determines that the vehicle 400 is approaching an end of a journey and initiates proactive localisation. In this embodiment, the processing means 204 recognises the parking area 402 in dependence on the GPS reading of the vehicle 400. A map, such as a HD map, of the parking area may already be available on a memory means associated with the vehicle, such as on a non-transitory computer readable memory 209. Alternatively, a map, such as a HD map of the parking area may be downloaded from a cloud based server, provided by a third party map provider. The map comprises information relating to the parking area, such as information relating to entrances 406a, 406b of the parking area 402. The information may comprise one or more photographs 408.

As the vehicle continues to approach the parking location 402, the processing means 204 may verify whether the recognised parking area is indeed the area in which the vehicle is located by comparing one or more signals 208 received by the sensing means 206 with said information relating to the parking area. Where the sensing means 206 comprises one or more cameras, the processing means 204 may compare observed scenes with one or more photographs 408 by way of known image processing techniques. This enables the apparatus 200 to retrieve a correct map of the parking area 402 to localise the vehicle 400. The map itself may store information relating to the parking area, such as a GPS location, images, a layout of an arrangement of parking bays within the parking location, etc. When a parking area 402 comprises multiple entrances 406a, 406b, in some embodiments, verification also comprises determining which of the entrances 406a, 406b the vehicle 400 is approaching, using the information comparison techniques as hereinbefore described.

After the parking area 402 has been recognised and optionally verified, high precision vehicle localisation is commenced whilst the vehicle 400 is still in motion, approaching or entering the parking area 402. The vehicle localisation may comprise comparing one or more signals 208 received by the sensing means 206 with expected signals in view of information stored in the map. During this period of dynamic localisation, sensing means 206, such as a camera, ultrasound, RADAR or LIDAR are able to scan and measure an environment proximal to the vehicle 400 more accurately and precisely than if the vehicle were stationary, helping the apparatus 200 to localise an initial position of the vehicle 400 prior to performing a manoeuvre, such as a low speed parking manoeuvre into a target parking bay 410.

In some embodiments, when the processing means 204 determines that the vehicle 400 has stopped inside the parking area 402, the output means 210 outputs a signal 212 to prompt the user 211 querying whether the user 211 would like to proceed with the manoeuvre. By this point, the vehicle 400 already has good knowledge of its initial position within the parking area 402. After the driver's confirmation 213 that they would like to proceed with the manoeuvre, the manoeuvre may be performed autonomously and immediately without any delay due to computation. Alternatively, instructions may be provided to the user 211, immediately without any delay due to computation, as to how to manually perform the manoeuvre themselves.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method for proactively localising a vehicle, the method comprising:
determining that the vehicle is approaching an end of a journey;
upon determining that the vehicle is approaching the end of the journey, sensing one or more features of an environment proximal to the vehicle whilst the vehicle is still in motion; and
localising the vehicle in dependence on said sensing.

2. The method of claim 1, wherein said sensing comprises sensing one or more features of an environment proximal to the vehicle by means of one or more of any of: RADAR, LIDAR, an ultrasound sensor and a camera.

3. The method of claim 1, wherein said determining that the vehicle is approaching the end of the journey comprises comparing a location of the vehicle with a predetermined location.

4. The method of claim 3, wherein the predetermined location comprises a location of a parking area.

5. The method of claim 3, wherein said localising is initiated when said comparing determines that the vehicle location is a predetermined distance from the predetermined location.

6. The method of claim 3, comprising verifying that a location of the vehicle substantially corresponds to the predetermined location.

7. The method of claim 1, wherein said determining that the vehicle is approaching an end of a journey comprises one or more of:
determining a reduction in vehicle speed,
determining whether one or more pre-determined landmarks are present, and
receiving a user initiated signal.

8. The method of claim 1, wherein said localising comprises comparing said one or more features of the environment proximal to the vehicle with one or more predetermined features.

9. The method of claim 1, wherein said localising is performed whilst the vehicle is still in motion.

10. The method of claim 1, comprising providing a user with a prompt querying whether the user would like to proceed with a parking manoeuvre.

11. The method of claim 10, wherein said prompt is provided upon one or more of:
a determination that the vehicle has stopped, and
a determination that the vehicle has entered a known parking area.

12. A non-transitory computer readable medium having computer readable instructions stored thereon which, when executed by a computer, perform a method according to claim 1.

13. Apparatus for proactively localising a vehicle, the apparatus comprising:
an input configured to receive one or more signals indicative of a position in a journey of the vehicle;
a processor configured to determine, in dependence on the one or more signals, whether the vehicle is approaching an end of a journey; and
a sensor configured to receive one or more signals indicative of one or more features of an environment proximal to the vehicle whilst the vehicle is still in motion;
wherein the processor is configured to localise the vehicle in dependence on the one or more features, upon determining that the vehicle is approaching the end of the journey.

14. The apparatus of claim 13, wherein the sensor comprises one or more of any of: RADAR, LIDAR, an ultrasound sensor and a camera.

15. The apparatus of claim 13, wherein the one or more signals comprise a signal indicative of a location of the vehicle.

16. The apparatus of claim 15, wherein the processor is configured to compare the signal indicative of a location of the vehicle with an expected signal of one or more predetermined locations.

17. The apparatus of claim 16, wherein the processor is configured to determine whether the vehicle is within a predetermined distance from the one or more predetermined locations.

18. The apparatus of claim 13, wherein the one or more signals comprise one or more of:
a signal indicative of a reduction in vehicle speed,
a signal indicative of a presence of one or more predetermined landmarks, and
an electronic signal initiated by depression of a button or a signal initiated by an audio command provided by a user.

19. An electronic system comprising the apparatus of claim 13.

20. A vehicle comprising the apparatus claim 13.
